(19) United States
(12) Patent Application Publication
(10) Pub. No.: US 2022/0027331 A1
(43) Pub. Date: Jan. 27, 2022

(54) Cross-Environment Event Correlation Using Domain-Space Exploration and Machine Learning Techniques

(71) Applicant: INTERNATIONAL BUSINESS MACHINES CORPORATION, Armonk, NY (US)

(72) Inventors: Jinho Hwang, Ossining, NY (US); Larisa Shwartz, Greenwich, CT (US); Srinivasan Parthasarathy, White Plains, NY (US); Qing Wang, Chappaqua, NY (US); Raghuram Srinivasan, Aurora, IL (US); Gene L. Brown, Durham, CT (US); Michael Elton Nidd, Zurich (CH); Frank Bagehorn, Dottikon (CH); Jakub Krchák, Jindrichuv Hradec (CZ); Ota Sandr, Prague (CZ); Tomáš Ondrej, Prague (CZ); Michal Mýlek, Vrané nad Vltavou (CZ); Altynbek Orumbayev, Prague (CZ)

(21) Appl. No.: 16/937,425

(22) Filed: Jul. 23, 2020

(51) Int. Cl. G06F 16/215; G06N 5/02; G06N 5/04; G06N 20/00

(52) U.S. Cl. CPC G06F 16/215; G06N 20/00; G06N 5/04; G06N 5/022

(57) ABSTRACT

A computer-implemented method of cross-environment event correlation includes determining one or more correlated events about an issue across a plurality of domains. A knowledge data is extracted from the issue determined from the one or more correlated events is performed. A correlation graph is generated from the extracted knowledge to trace the issue and group the correlated events into one or more event groups to represent their relationship with the issue. A logical reasoning description is constructed based on the generated correlation graph for a domain-space exploration related to how the issue in one domain affects another domain of the plurality of domains. The one or more event groups of correlated events is provided with an explanation about a cause of the issue based on the logical reasoning description.

### BACKGROUND

### Technical Field

The present disclosure generally relates to event correlation in multiple domain operations, and more particularly, to systems and methods for cross-environment event correlation of multiple domain operations.

### Description of the Related Art

As the information technology (IT) environment becomes more entangled, there is an increased interaction between different domains of a multiple domain computing environment. The result of such interaction is that a problem in one domain can affect the operations in other domains. Events or changes that originate in one of the respective domains are often made and reviewed independently, even though other domains may be affected by the events or changes.

For example, a rule or policy change made in one domain can cause an issue, a problem or an incident in the operation of a network device in another domain that is not easily discoverable. An issue in a storage server can adversely impact applications operating in another domain when a cross-domain communication is required. The debugging of an issue can be prolonged as events in different domains may not appear to be co-related. It is also challenging to understand the risks presented to other domains when a change or a problem occurs.

### SUMMARY

According to one embodiment, a computer-implemented method of cross-environment event correlation includes the operations of determining one or more correlated events about an issue across a plurality of domains. A knowledge data of the issue determined is extracted from the one or more correlated events is performed. A correlation graph is issued of the extracted knowledge data to trace the issue and group the correlated events into one or more event groups to represent their relationship with the issue. A logical reasoning description is constructed based on the generated correlation graph for a domain-space exploration related to how the issue in one domain affects another domain of the plurality of domains. The one or more event groups of correlated events are provided with an explanation about a cause of the issue based on the logical reasoning description. The identification of the cause of an issue and the explanation facilitates diagnosis and corrective action to address an issue.

In one embodiment, the extracting of the knowledge data includes extracting one or more of a semantic knowledge data or a meta-knowledge data, and machine learning is utilized to determine the correlated events about the issue across a plurality of domains based on a history data or a synthetic data. The use of machine learning permits discovery of an event correlation that might otherwise be missed, and results in a time savings in diagnosis and an explanation of the cause of an issue, particularly across a plurality of domains.

In one embodiment, the use of machine learning includes training by an unsupervised learning technique using an association rule learning algorithm or a clustering algorithm. The unsupervised learning technique is particularly beneficial to discover correlations that otherwise may not have been detected.

In one embodiment, the use of machine learning includes training by a supervised learning technique using labeled data associated with data correlation. The use of a supervised learning technique can be used to direct the determining of correlated events to obtain more efficient results.

In one embodiment, the use of machine learning includes configuring by a supervised learning technique using a support vector machine (SVM), a convolutional neural network (CNN), or a long-short term memory (LSTM) based on a size of the correlation data. The use of SVM, CNN, and LSTM can provide for an increased correlation of events.

In one embodiment, the recommending of a most probable event group of correlated events of the one or more event groups to users with an explanation about a cause of the issue based on the logical reasoning description. There is an increased efficiency by the recommended probable event group.

In one embodiment, the recommending of the most probable event group of correlated events with an explanation of the cause of an issue is based on the logical reasoning description that includes performing in runtime a creating, reading, updating, and deleting (CRUD) of data. The use of CRUD brings a more dynamic recommending of the most probable event group than collecting data from logs.

In one embodiment, the use of machine learning includes a training operation based on feedback is received to train for the determining of the one or more correlated events.

In one embodiment, feedback is received to determine the one or more correlated events by an active learning methodology, which interactively queries a user or another information source to label new data points with the desired outputs. The feedback provides an advantage in the training operations in machine learning.

In one embodiment, one or more semantic relationships are constructed between the plurality of domains. There is a benefit in the determining of correlated events.

In one embodiment, the determining of one or more correlated events about an issue includes collecting one or more an event, a log, or a change record from at least some of the plurality of domains. One or more correlated events about the issue are determined by using machine learning techniques. Normalized formats are produced of the one or more collected events, logs or change records. Cross-domain event correlation is enhanced by the normalizing of formats.

In one embodiment, the collecting of events, logs, metrics, or change records is performed offline by using synthetic simulation.

In one embodiment, the collecting of events, logs, metrics, or change records is performed offline by using history data.

A non-transitory computer-readable storage medium tangibly embodying a computer-readable program code having computer-readable instructions that, when executed, causes a computer device to perform a method of cross-environment event correlation, the method includes determining one or more correlated events about an issue across a plurality of domains. A knowledge data of the issue is extracted from the one or more correlated events. A correlation graph of the extracted knowledge data is generated to trace the issue and group the correlated events into one or more event groups. A logical reasoning description is constructed based on the generated correlation graph for a domain-space exploration related to how the issue in one domain affects another domain of the plurality of domains. The one or more event groups of correlated events are provided with an explanation about a cause of the issue based on the logical reasoning description. The identification of the cause of an issue and the explanation facilitates diagnosis and corrective action to address an issue.

In one embodiment, a computing device for cross-environment event correlation using space-exploration includes a processor, and a memory coupled to the processor. The memory storing instructions to cause the processor to perform acts including: determining one or more correlated events about an issue across a plurality of domains, extracting a knowledge data of the issue determined from the one or more correlated events; constructing a logical reasoning description for domain-space exploration related to how the issue in one domain affects another domain of the plurality of domains; generating correlation graphs based on the domain-space exploration to trace the issue and group the correlated events in one or more groups; constructing semantic relationships between different domains, and recommending the most probable event groups of correlated events with an explanation about a cause of the issue based on the logical reasoning description. The monitoring of events from different domains can be performed and an understanding of risks associated with changes or mutations in one domain and the impact on other domains can be provided.

In one embodiment, the extracting of the knowledge data includes extracting one or more of a semantic knowledge data or a meta-knowledge data, the processor is configured to perform machine learning of the cross-environment event correlation about the issue.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition to, or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 is an overview of an architecture of a system for cross-environment event correlation, consistent with an illustrative embodiment.

FIG. 2 is a system flow diagram for cross-environment event correlation using domain space exploration, consistent with an illustrative embodiment.

FIG. 3 illustrates a problem scenario in a cloud native environment that is addressed in the present disclosure.

FIG. 4 illustrates another problem scenario in a hybrid-cloud environment that is addressed in the present disclosure.

FIG. 5 illustrates a domain-space operation, consistent with an illustrative embodiment.

FIG. 6 illustrates the construction of correlation graphs, consistent with an illustrative embodiment.

FIG. 7 is a screenshot used in the building of a logical reason description, consistent with an illustrative embodiment.

FIG. 8 is a flowchart of a computer-implemented method for cross-environment event correlation, consistent with an illustrative embodiment.

FIG. 9 is a functional block diagram of a particularly configured computer hardware platform that can communicate with various networked components, consistent with an illustrative embodiment.

FIG. 10 depicts an illustrative cloud computing environment utilizing cloud computing.

FIG. 11 depicts a set of functional abstraction layers provided by a cloud computing environment.

### DETAILED DESCRIPTION

### Overview

In the following detailed description, numerous specific details are set forth by way of examples to provide a thorough understanding of the relevant teachings. However, it should be understood that the present teachings may be practiced without such details. In other instances, well-known methods, procedures, components, and/or circuitry have been described at a relatively high-level, without detail, to avoid unnecessarily obscuring aspects of the present teachings.

The present disclosure provides a computer-implemented method and system for cross-environment correlation. In multi-domain environments, events or changes that originate from different domains are typically reviewed independently without any correlation to upstream or downstream associations. As used herein, the term “issue” includes a problem or an incident in a multi-domain environment. Accordingly, an issue of a network device (e.g., a down or rule/policy change) in the path of communications between two applications can have a large impact on performance, and may even disable communications. Moreover, by way of an example, an issue with regard to a storage server (e.g., a scalability change, a bandwidth change, an authentication change, etc.,) that is attached as a Kubernetes persistence volume can significantly impact running an application and/or the scalability of the Kubernetes persistence volume of a cluster to grow while retaining its service-level objectives. The debugging of an issue based on an event in one domain can vary greatly both in time and complexity if the issue is affecting other domains, as the events may not be co-related, and/or expertise in other domains may not be at the level of the expertise in the domain where the event occurred. The computer-implemented method and system of the present disclosure can permit monitoring of events from different domains and provide an understanding of risks associated with changes or mutations in one domain and the impact on other domains.

The terms “semantic knowledge” and “meta-knowledge” are used herein. While there is some overlap between the two terms, semantic knowledge includes knowledge about words or phrases, and can include concepts, facts, and ideas. Meta-knowledge is a knowledge about a pre-selected knowledge or content, and includes, tagging, planning, modeling and learning modifications of a domain language.

In addition, the computer-implemented system and method according to the present disclosure provide for an improvement at least in the fields of the operation monitoring and risk assessment of multi-domain computing environments and the inter-related effects of the different domains on each other. In addition, the computer-implemented method and system of the present disclosure provide an improvement in the efficiency of computer operations, as the use of machine learning, for example, to monitor and assess the cross-environment correlation can increase reliability, and reduce or eliminate degraded operations in one or more domains due to an issue in another domain.

### Example Architecture

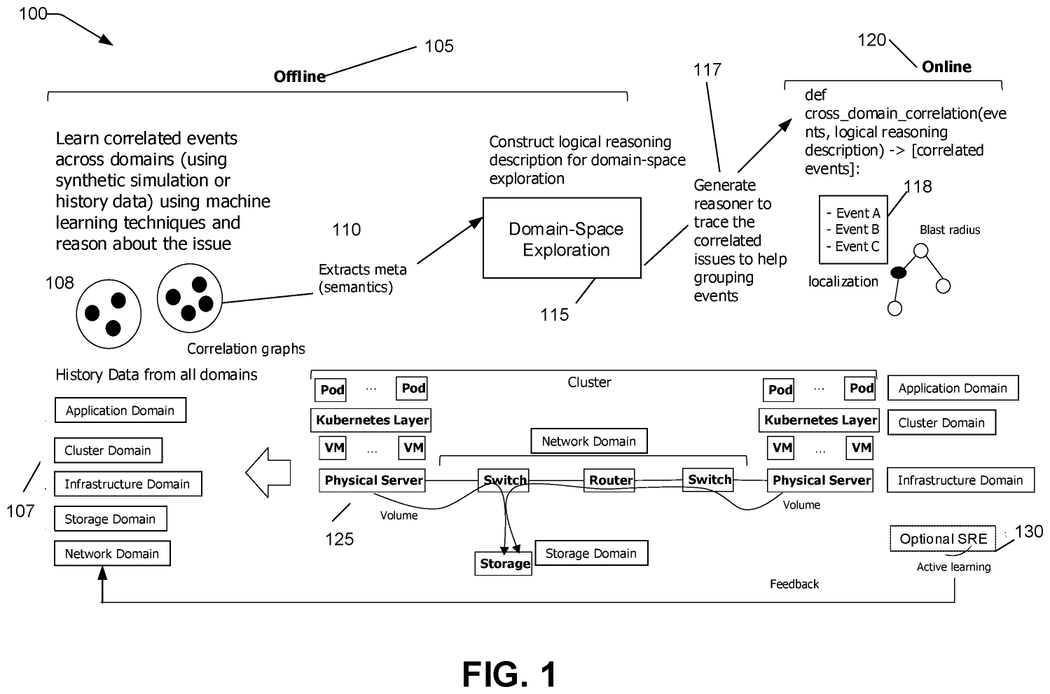

FIG. 1 is an overview of an architecture 100 of a system for cross-environment event correlation, consistent with an illustrative embodiment. As shown in the bracket offline 105, some of the operations may be performed with a system being offline, which can include data retrieval by collecting events, logs, metrics, or change records from various domains, using e.g., synthetic simulation or history data. A non-limiting example of domains 107 is shown, from which the history data may be obtained. Normalized formats may be generated from the retrieved data. There can be machine learning of correlated events 108 across domains and an explanation about a cause of the issue, for example, based on analyzing the issue.

With continued reference to FIG. 1, semantic knowledge or meta-knowledge 110 can be extracted from the retrieved data, and a correlation graph (e.g., a knowledge graph) is generated to trace the correlated issues to help the grouping of events. There is a domain-space exploration 115 performed to construct a logical reasoning description for the domain space exploration. The correlated issues help to trace the correlated issues to help grouping events.

Under the bracket marked “online” 120 there are some runtime functions. For example, in runtime, there can be a cross-domain correlation of events or a create/read/update/delete (CRUD) operation to return a grouped event with an explanation about a cause of the issue. In one embodiment, there is a physical server 125 coupled to persistent storage (e.g., a Kubernetes layer) coupled with pods. Optionally, a system reliability engineer 230 can provide feedback in a training operation.

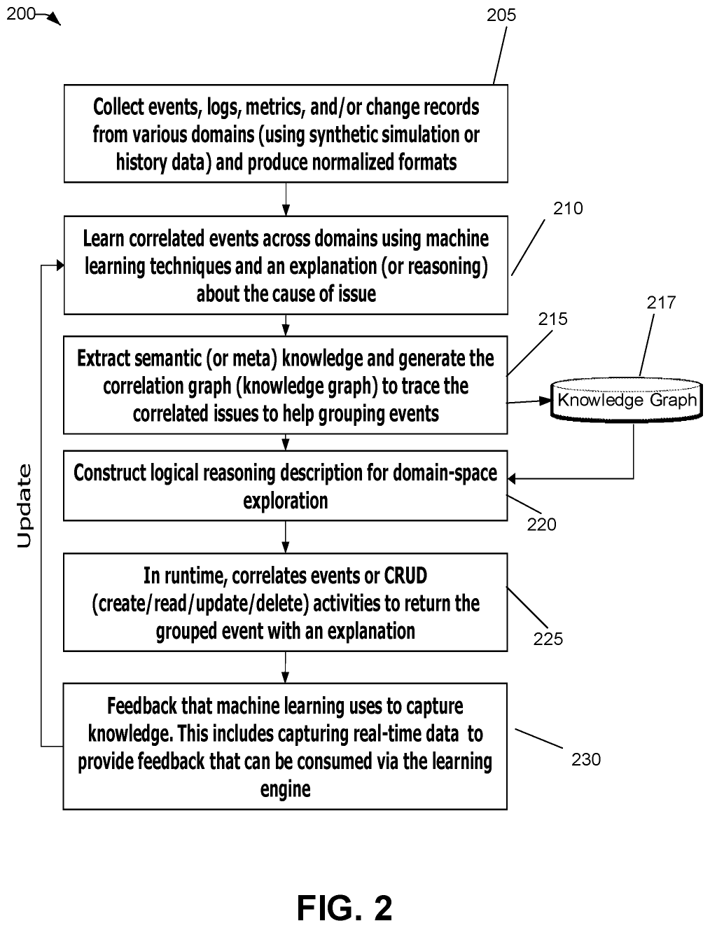

FIG. 2 is a system flow diagram 200 for cross-environment event correlation using domain space exploration, consistent with an illustrative embodiment. At operation 205, the data from various domains are collect in the form of, for example, events, logs, metrics change records, etc. This data can be used to produce normalized formats.

At operation 210, there is a learning of correlated events occurring across domains using machine learning techniques. As discussed herein, the machine learning may be based on supervised or unsupervised training. For example, the correlated events can be identified for grouping into one or more correlated groups with a confidence level. In unsupervised learning, there can be frequency-based approaches such as an association rule learning algorithm. In addition, similarity-based approaches, such as clustering algorithms, can be used with an association rule learning algorithm. In supervised learning techniques, there is a use of labeled data associated with a data correlation, or labels are created with a data correlation. In one example, a problem incident can be identified with tickets that include multiple events that are closed together. In addition, if the size of data is relatively small, traditional machine learning algorithms, such as a support vector machine (SVM), can be used for the classifications. In the case of big data, deep learning algorithms such as convolutional neural networks (CNN), long-short term memory (LSTM), etc., can be used.

At operation 215, an extracting of the meta-knowledge (or semantic knowledge) is performed, and used to generate a correlation graph (e.g., knowledge graph 217) to trace the correlated issues for the grouping of events. Meta-knowledge can be extracted number of ways, for example, by reading tags, extracting quantitative data sets, and using an information extraction (IE) system, or by an event-based information extraction software. At operation 220, a constructing of a logical reasoning description from domain-space exploration is performed. For example, in domain-space exploration, there can be a number of operations performed, such as exploring of the attributes that have occurred in each domain from analyzing the history data, a combining of entities with relation (e.g., entity linking), extracting a knowledge base, and constructing a knowledge graph. A correlating of types of events with similar cluster types can be based on the temporal and spatial information.

At operation 225, during runtime, there is a correlation of events performed to identify a group of events, and to return the grouped event with an explanation of a cause of an issue. The actions used to identify and return a grouped event with an explanation of the cause of an issue include performing actions such as create/read/update/delete (referred to in the art as “CRUD”). Then at operation 230, feedback to capture knowledge of the correlated events may be provided to the machine learning of correlated events 210 based on capturing and analyzing real-time data. Feedback can be generated to determine the one or more correlated events by an active learning methodology, which interactively queries a user or another information source to label new data points with the desired outputs. Optionally, a site reliability engineer (SRE) or a subject matter experts (SMEs) can supplement the feedback.

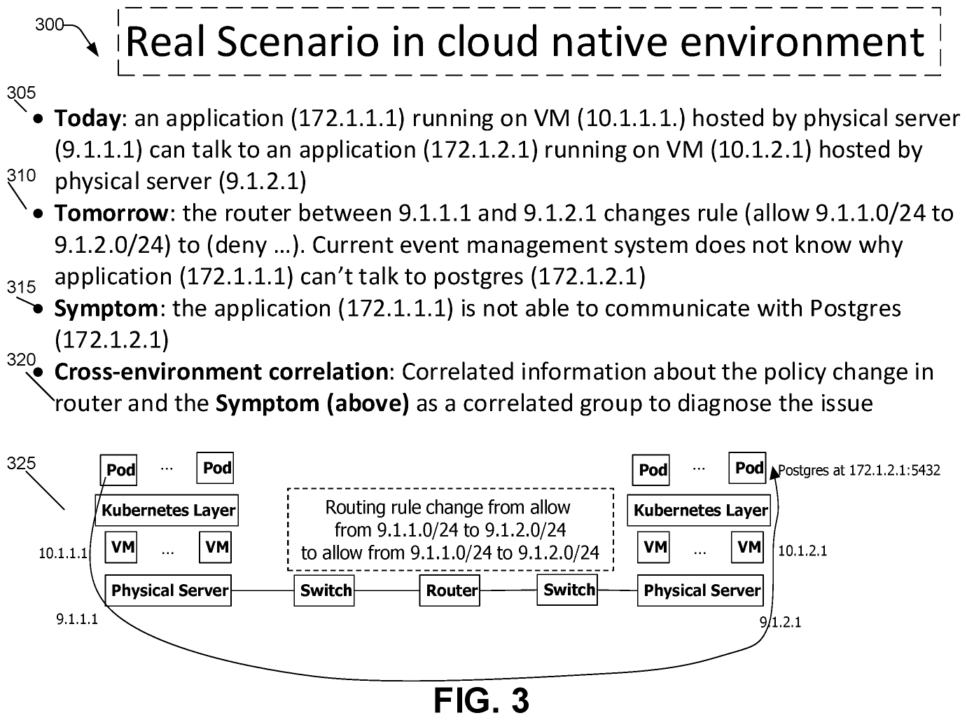

FIG. 3 illustrates an example of a problem scenario 300 in a cloud native environment that is addressed in the present disclosure. FIG. 3 lists the state of the environment today 305, tomorrow 310, the symptom 315, and the cross-environment correlation. A schematic 325 of the environment is also shown.

In the “today” 305 state, an application “172.1.1.1” running on VM 10.1.2.1, is hosted by a physical server 9.1.1.1. The application 172.1.1.1 can communicate with another application “postgres 172.1.2.1”, which is hosted by another physical server 9.1.2.1. However, in the “tomorrow” 310 state, the router 327 between the two physical servers changes a rule to “deny”, and now the application 172.1.1.1 cannot communicate with the postgres 172.1.2.1 application. The current event management system is not aware of the rule change in the router 327, and it is not known why the application 172.1.1.1 cannot communicate with postgres 172.1.2.1 application. Through performing cross-environment correlation, the information about the policy change in the router, and the symptom are correlated as a group to diagnose the issue.

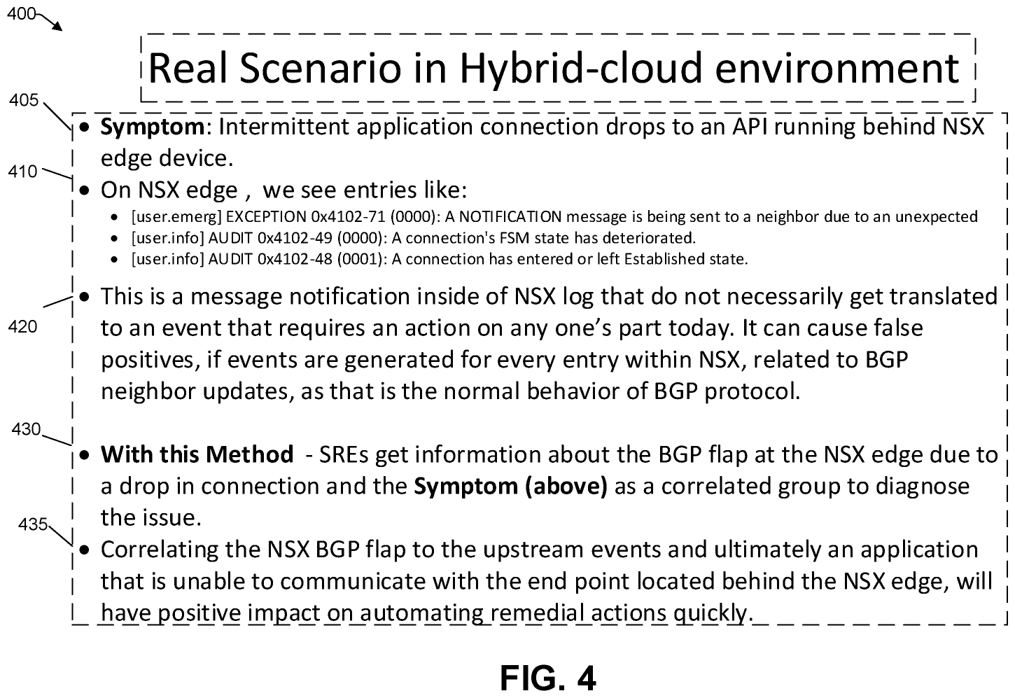

FIG. 4 illustrates an example of a problem scenario 400 in a hybrid-cloud environment that is addressed in the present disclosure. In this illustration, the environment is a hybrid cloud, and the symptom 405 is that there is an intermittent application connection dropping to an application program interface (API) running behind a device operating NSX® software. The NSX® edge messages 410 state that a notification is being sent to a neighbor due to an unexpected condition, followed by a message that a connection's state has deteriorated, and that a connection has entered or left an established state. The messages, starting with an indication of an unexpected condition through the message regarding the connection has left an established state, are the sequence of the application dropping to the API. An explanation at 420 indicates that such message notifications normally do not get translated to an event as no action may be required, and that false positive messages can be generated, particularly if it related to Border Gateway Protocol (BGP), which is a standardized exterior gateway protocol that is designed to exchange information about routing and reachability among autonomous systems on the Internet. According to a method of the present disclosure, at 430 it is indicated that these types of messages and the symptom are correlated as a group to diagnose the issue and provided to an SRE or an automated remedial action file of similar messages that may be searchable. At 435, it is indicated that by correlating the group events regarding the application connection drops (referred to as an “NSX BGP flap”) to upstream events, and providing the information to an automated remedial action file of similar messages or an SRE will permit a faster ability to diagnose and undertake remedial actions with an application unable to communicate with an end point located behind the NSX edge.

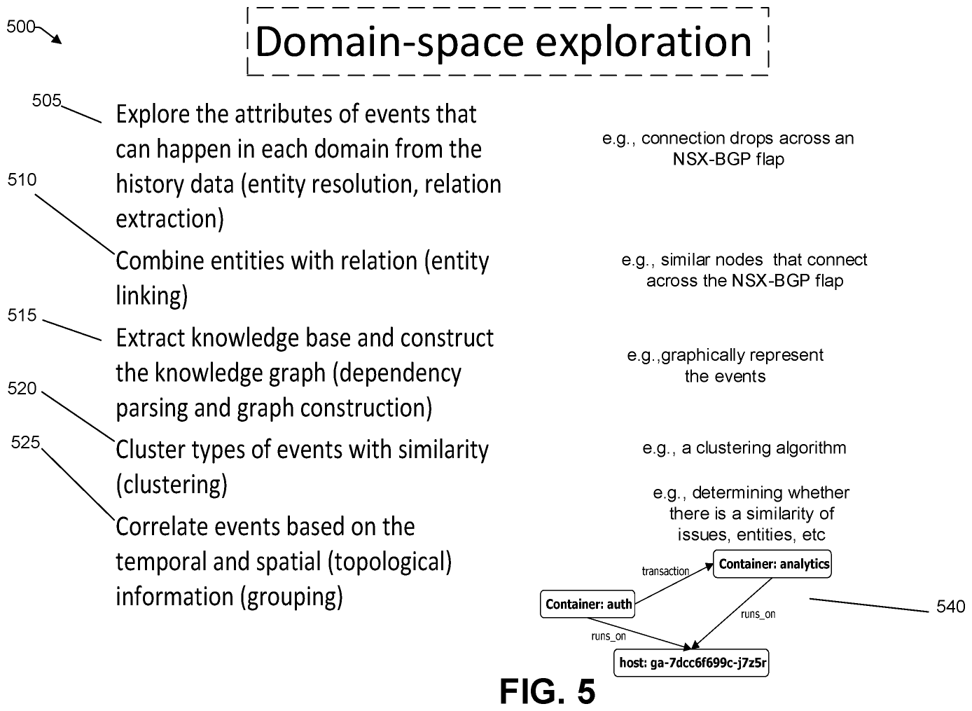

FIG. 5 illustrates a domain-space exploration 500 operation, consistent with an illustrative embodiment. According to FIG. 5, in a domain-space exploration, the attributes of events that can happen in each domain are explored from history data. One such example can be connection drops across an NSX-BGP flap as discussed above with regard to FIG. 4. At operation 510 there is a combining of entities with a relation (e.g., entity linking). With regard to the scenario discussed in FIG. 4, the combining of entities can include linking information regarding similar nodes that connect across the NSX-BGP flap.

At operation 515, the knowledge base is extracted and a knowledge graph is constructed using, for example, by dependency parsing and graph construction. For example, the events can be graphically represented to make it easier to determine if there is a pattern or commonality to any problems.

At operation 520, clustering is performed on types of events having similarities and events that are correlated based on the temporal and spatial (e.g., topological) information (e.g., grouping). A clustering algorithm can be used to correlate common issues and/or issues with entities sharing similar connections with certain applications. The domain-space exploration 540 is shown, with the relationship between container authorization, container analytics, and a host.

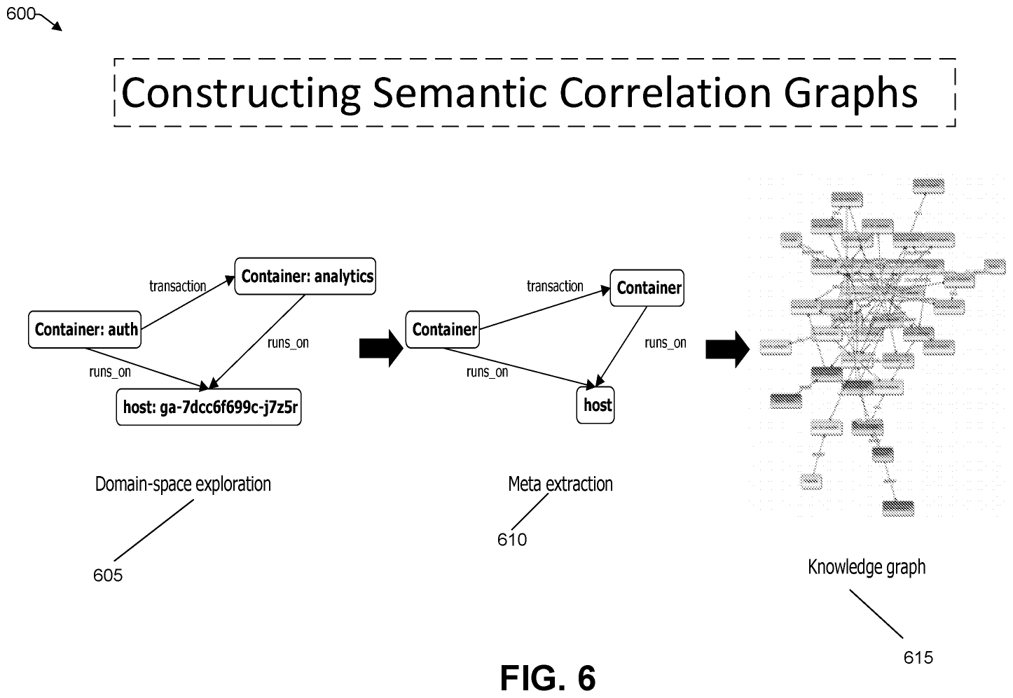

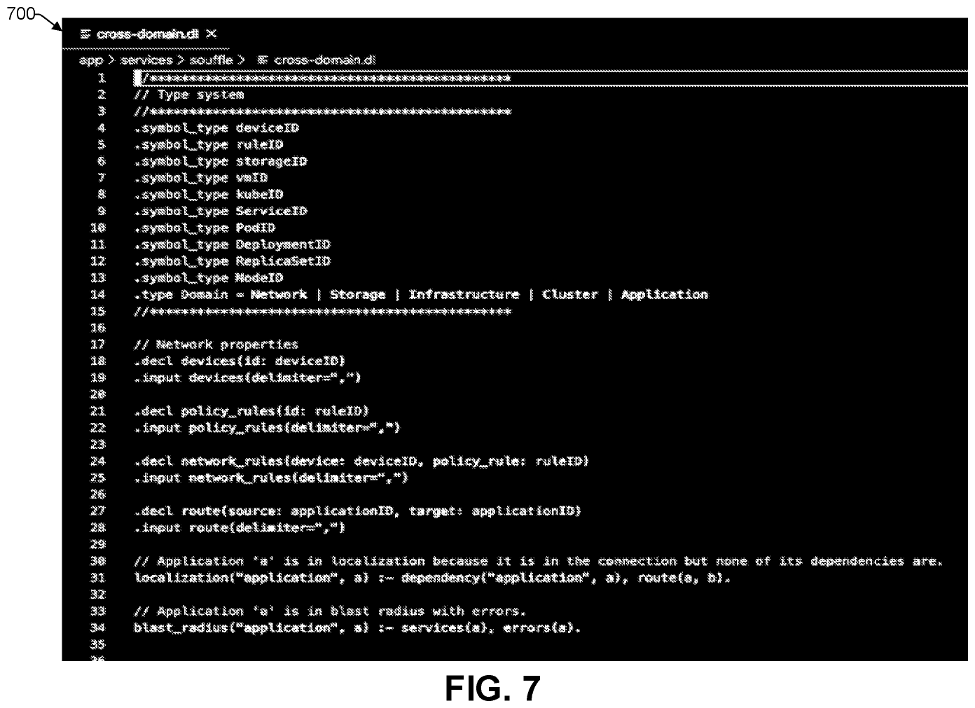

FIG. 6 illustrates the construction of correlation graphs 600, consistent with an illustrative embodiment. The domain-space exploration 605, a meta-extraction 610, and a knowledge graph 615 are shown. The semantic correlation graph is constructed with learned information, and the meta-information is extracted from the domain-space exploration and converted to the knowledge graph. The domain-space exploration 605 depicts a relationship between container authorization, container analytics, and a host. The meta-extraction 610 can be extracted number of ways, for, example, by reading tags, extracting quantitative data sets, by using an information extraction (IE) system, or by an event-based information extraction software. The knowledge graph 615 is a programmatic way to model domain information, as it shows the links between various domains. There are various applications that can generate knowledge graphs, and their use can be applied to problem determination by providing links of events that may have occurred by various domains. FIG. 7 is a sample screenshot 700 used in the building of a logical reason description, consistent with an illustrative embodiment. The screenshot 700 is an example of space exploration logic used to find reasoning for localization and a blast radius. With the data from the domain-space exploration, deep design space explorations logic is updated with logic with iterative learning and optional SRE feedback (or an automated feedback). In runtime, the correlated events and reasoning can be found.

### Example Process

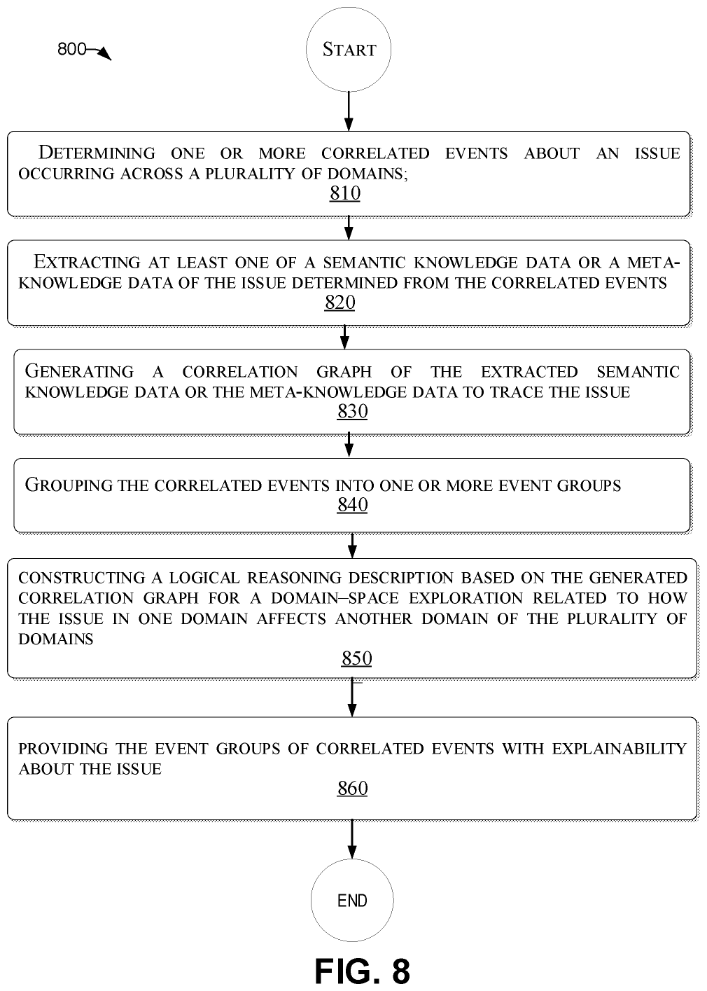

With the foregoing overview of the example architecture, it may be helpful now to consider a high-level discussion of an example process. To that end, in conjunction with FIGS. 1 and 2, FIG. 8 is a flowchart a computer-implemented method for cross-environment event correlation, consistent with an illustrative embodiment. Process 800 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process. For discussion purposes, the process 800 is described with reference to the architecture of FIG. 1.

At operation 810, one or more correlated events are determined about an issue occurring across a plurality of domains. The issue can range, for example, from a hard failure to a degradation of service. The correlated events can have some type of commonality as a basis for grouping.

At operation 820, at least one of a semantic knowledge data, or a meta-knowledge data of the issue determined from the correlated events are extracted. The meta-knowledge may be extracted, for example, from a domain-space exploration. The meta-knowledge can be extracted a number of ways, such as by reading tags, extracting quantitative data sets, and using an information extraction (IE) system, or by an event-based information extraction software.

At operation 830, a correlation graph of the extracted semantic knowledge data or the meta-knowledge data is generated to trace the issue.

At operation 840, the correlated events are grouped into one or more event groups. The events may be based on similar types of errors (e.g., network flapping such as discussed with regard to FIG. 4), or errors occurring with a particular gateway, errors occurring at a similar period of time.

At operation 850, a logical reasoning description is constructed based on the generated correlation graph. The correlation graph for a domain-space exploration is related to how the issue in one domain affects another domain of the plurality of domains.

At operation 860, the event groups of correlated events are provided with an explanation about a cause of the issue. The explanation provides a better understanding about the issue.

The process in this illustrative embodiment ends after operation 860.

### Example Particularly Configured Computing Device

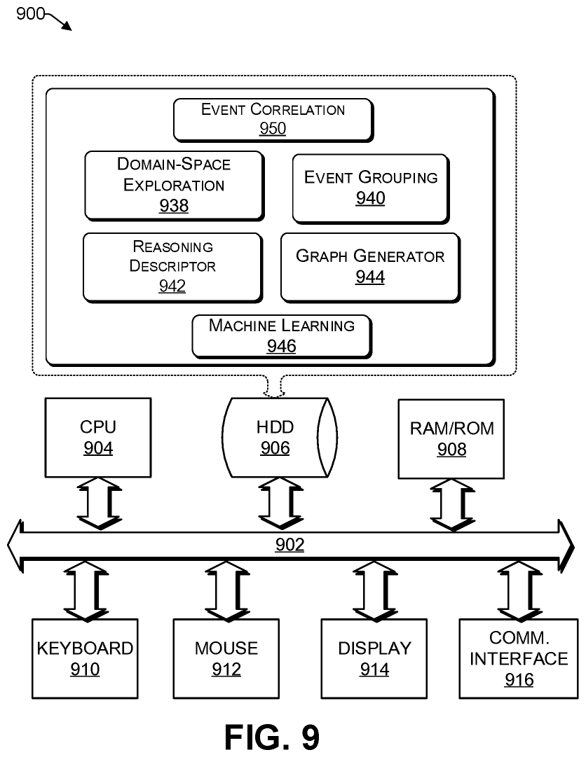

FIG. 9 provides a functional block diagram illustration of a computer hardware platform 900. In particular, FIG. 9 illustrates a particularly configured network or host computer platform 900, as may be used to implement the method as discussed herein above.

The computer platform 900 may include a central processing unit (CPU) 904, a hard disk drive (HDD) 906, random access memory (RAM) and/or read-only memory (ROM) 908, a keyboard 910, a mouse 912, a display 914, and a communication interface 916, which are connected to a system bus 902. The HDD 906 can include data stores.

In one embodiment, the HDD 906, has capabilities that include storing a program that can execute various processes, such as for executing cross-environment event correlation 950, in a manner described herein. The cross-environment event correlation module 950 includes a domain-space exploration module 938, and an event grouping module 940, A reasoning descriptor 942 generates a logical reasoning for domain-space exploration. A graph generator module 944 is configured to generate a correlation graph from extracted semantic or meta knowledge to trace the correlated issues to help group events. There can be various modules configured to perform different functions that can vary in quantity. For example, a machine learning module 946 may be configured to learn the cross-domain correlations and reason about the issue. Given data (history or synthetic), the correlated events are identified as a correlated group with a confidence level.

In one embodiment, a program, such as Apache™, can be stored for operating the system as a Web server. In one embodiment, the HDD 906 can store an executing application that includes one or more library software modules, such as those for the Java™ Runtime Environment program for realizing a JVM (Java™ virtual machine).

### Example Cloud Platform

As discussed above, functions related to cross-environment event correlation according to the present disclosure may include a cloud. It is to be understood that although this disclosure includes a detailed description of cloud computing as discussed herein below, implementation of the teachings recited herein is not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

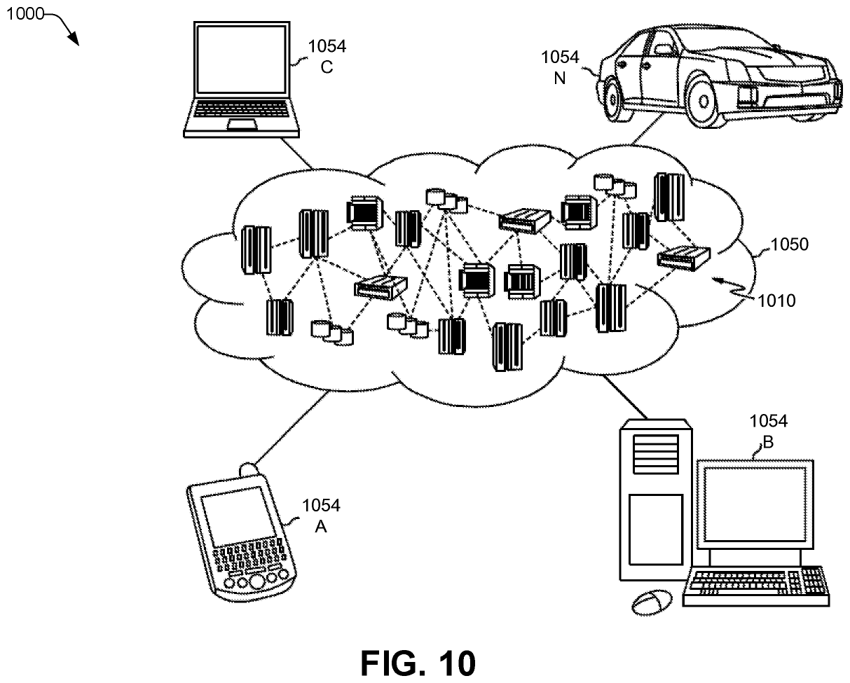

Referring now to FIG. 10, an illustrative cloud computing environment 1000 utilizing cloud computing is depicted. As shown, cloud computing environment 1000 includes cloud 1050 having one or more cloud computing nodes 1010 with which local computing devices used by cloud consumers, such as, for example, personal digital assistant (PDA) or cellular telephone 1054A, desktop computer 1054B, laptop computer 1054C, and/or automobile computer system 1054N may communicate. Nodes 1010 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms, and/or software as services for which a cloud consumer does not need to maintain resources on a local computing device. It is understood that the types of computing devices 1054A-N shown in FIG. 10 are intended to be illustrative only and that computing nodes 1010 and cloud computing environment 1050 can communicate with any type of computerized device over any type of network and/or network addressable connection (e.g., using a web browser).

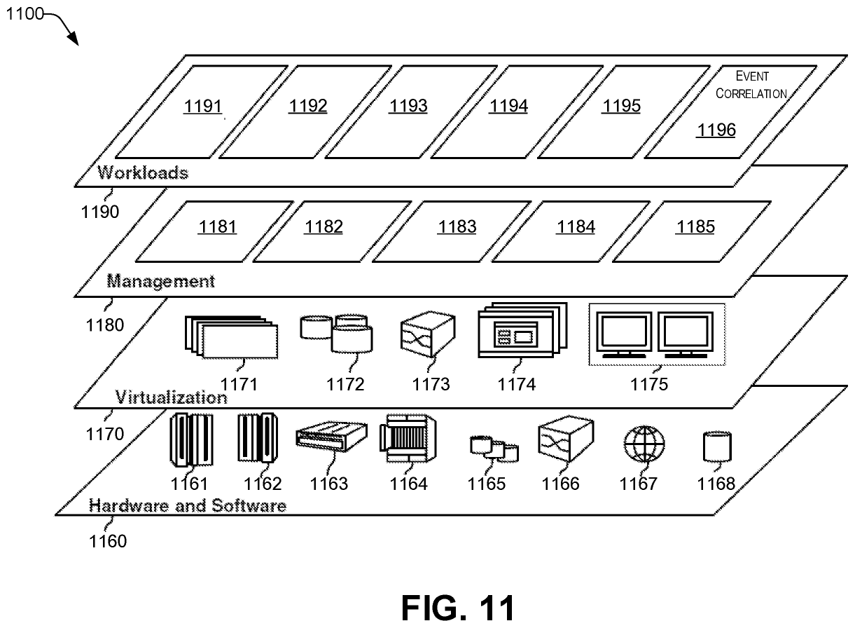

Referring now to FIG. 11, a set of functional abstraction layers 1100 provided by cloud computing environment 1000 (FIG. 10) is shown. It should be understood in advance that the components, layers, and functions shown in FIG. 11 are intended to be illustrative only and embodiments of the disclosure are not limited thereto. As depicted, the following layers and corresponding functions are provided:

Hardware and software layer 1160 include hardware and software components. Examples of hardware components include: mainframes 1161; RISC (Reduced Instruction Set Computer) architecture based servers 1162; servers 1163; blade servers 1164; storage devices 1165; and networks and networking components 1166. In some embodiments, software components include network application server software 1167 and database software 1168.

Virtualization layer 1170 provides an abstraction layer from which the following examples of virtual entities may be provided: virtual servers 1171; virtual storage 1172; virtual networks 1173, including virtual private networks; virtual applications and operating systems 1174; and virtual clients 1175.

In one example, management layer 1180 may provide the functions described below. Resource provisioning 1181 provides dynamic procurement of computing resources and other resources that are utilized to perform tasks within the cloud computing environment. Metering and Pricing 1182 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1183 provides access to the cloud computing environment for consumers and system administrators. Service level management 1184 provides cloud computing resource allocation and management such that required service levels are met. Service Level Agreement (SLA) planning and fulfillment 1185 provide pre-arrangement for, and procurement of, cloud computing resources for which a future requirement is anticipated in accordance with an SLA.

Workloads layer 1190 provides examples of functionality for which the cloud computing environment may be utilized. Examples of workloads and functions which may be provided from this layer include: mapping and navigation 1191; software development and lifecycle management 1192; virtual classroom education delivery 1193; data analytics processing 1194; transaction processing 1195; and an event correlation module 1196, as discussed herein.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

The flowchart, and diagrams in the figures herein illustrate the architecture, functionality, and operation of possible implementations according to various embodiments of the present disclosure.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any such actual relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method for cross-environment event correlation, the method comprising:
determining one or more correlated events about an issue occurring across a plurality of domains;
extracting a knowledge data of the issue determined from the one or more correlated events;
generating a correlation graph of the extracted knowledge data to trace the issue;
grouping the correlated events into one or more event groups to represent a relationship with the issue;
constructing a logical reasoning description based on the generated correlation graph for a domain-space exploration related to how the issue in one domain affects another domain of the plurality of domains; and
providing the one or more event groups of correlated events with an explanation about a cause of the issue for the one or more correlated events based on the logical reasoning description.

2. The computer-implemented method of claim 1, further comprising using machine learning for the determining of the correlated events about the issue occurring across a plurality of domains based on a history data or a synthetic data, wherein the extracting of the knowledge data includes extracting one or more of a semantic knowledge data or a meta-knowledge data.

3. The computer-implemented method of claim 2, wherein using the machine learning includes training by an unsupervised learning technique using an association rule learning algorithm or a clustering algorithm.

4. The computer-implemented method of claim 2, wherein using the machine learning includes training by a supervised learning technique using labeled data associated with a data correlation.

5. The computer-implemented method of claim 2, further comprising configuring the machine learning by a supervised learning technique using a support vector machine (SVM), a convolutional neural network (CNN), or a long-short term memory (LSTM) based on a size of the correlation data.

6. The computer-implemented method of claim 2, further comprising:
recommending a most probable event group of correlated events of the one or more event groups to users with an explanation about the cause of the issue.

7. The computer-implemented method of claim 6, wherein the recommending of the most probable event group of correlated events with the explanation of the cause of the issue is based on performing in a runtime a creating, reading, updating, and deleting (CRUD) of data.

8. The computer-implemented method of claim 6, wherein using the machine learning includes a training operation based on receiving feedback to train for the determining of the one or more correlated events.

9. The computer-implemented method of claim 6, further comprising receiving feedback for the determining of the one or more correlated events by an active learning methodology which interactively queries a user or an information source to label new data points with desired outputs.

10. The computer-implemented method of claim 1, further comprising constructing one or more semantic relationships between the plurality of domains.

11. The computer-implemented method of claim 1, wherein the determining of one or more correlated events about an issue comprises:
collecting one or more of an event, a log, or a change record from at least some of the plurality of domains;
determining one or more correlated events about the issue by using one or more machine learning techniques; and
producing normalized formats of the one or more collected events, logs, or change records.

12. The computer-implemented method of claim 11, wherein at least the collecting of the event, the log, the metric, or the change record is performed offline using a synthetic simulation.

13. The computer-implemented method of claim 11, wherein at least the collecting of the event, the log, the metric, or the change record is performed offline using history data.

14. A non-transitory computer-readable storage medium tangibly embodying a computer-readable program code having computer-readable instructions that, when executed, causes a computer device to perform a method of cross-environment event correlation, the method comprising:
determining one or more correlated events about an issue across a plurality of domains;
extracting a knowledge data of the issue determined from the one or more correlated events;
generating a correlation graph of the extracted knowledge data to trace the issue;
grouping the correlated events into one or more event groups to represent a relationship with the issue;
constructing a logical reasoning description based on the generated correlation graph for a domain-space exploration related to how the issue in one domain affects another domain of the plurality of domains; and
providing the one or more event groups of correlated events with an explanation about a cause of the issue for the one or more correlated events based on the logical reasoning description.

15. The computer-readable storage medium according to claim 14, wherein:
the extracting of the knowledge data includes extracting one or more of a semantic knowledge data or a meta-knowledge data, and
the determining of the one or more correlated events is performed by machine learning; and
the method further comprises recommending a most probable event group of correlated events of the one or more event groups to users with explainability about the issue.

16. The computer-readable storage medium according to claim 14, wherein the recommending of the most probable event group of correlated events with explainability is based on performing in a runtime a creating, reading, updating and deleting (CRUD) of data.

17. The computer-readable storage medium according to claim 14, the method further comprising constructing one or more semantic relationships between the plurality of domains, and wherein the determining one or more correlated events about an issue comprises:
collecting one or more of events, one or more logs, one or more metrics, or one or more change records from at least some of the plurality of domains;
determining one or more correlated events about the issue by using machine learning techniques; and
producing normalized formats of the one or more collected events, one or more logs, or one or more change records.

18. The computer-readable storage medium according to claim 17, wherein the collecting of events, logs, metrics, or change records is performed offline using a synthetic simulation or a history data.

19. A computing device for cross-environment event correlation using space-exploration, comprising:
a processor;
a memory coupled to the processor, the memory storing instructions to cause the processor to perform acts comprising:
determining one or more correlated events about an issue across a plurality of domains;
extracting a knowledge data of the issue determined from the one or more correlated events;
constructing a logical reasoning description for domain-space exploration related to how the issue in one domain affects another domain of the plurality of domains;
generating one or more correlation graphs based on the domain-space exploration to trace the issue;
grouping the correlated events in one or more groups;
constructing semantic relationships between different domains, and
recommending the most probable event groups of correlated events with an explanation about a cause of the issue for the one or more correlated events based on the logical reasoning description.

20. The computing device according to claim 19, wherein:
the extracting of the knowledge data includes extracting one or more of a semantic knowledge data or a meta-knowledge data, and
the processor is configured to perform machine learning of the cross-environment event correlation about the issue.
